(19) United States
(12) Patent Application Publication
(10) Pub. No.: US 2006/0053604 A1
(43) Pub. Date: Mar. 16, 2006

(54) Methods for providing a memorial

(76) Inventor: William H. Brine, Hanover, NH (US)

Correspondence Address: Jenifer E. Haeckl, Esq.;Mirick, O'Connell, DeMallie & Lougee, LLP, 100 Front Street, Worcester, MA, 01608-1477, US

(21) Appl. No.: 10/939,527

(22) Filed: Sep. 13, 2004

(51) Int. Cl. A61G 17/00

(52) U.S. Cl. 27/1

(57) ABSTRACT

A method for providing a memorial for a deceased person or animal whose bodily remains have been cremated into ashes, generally including the steps of: providing a location at a facility; installing a crypt at the location; providing at least a portion of the ashes; enclosing the ashes in a vessel; and enclosing the vessel in the crypt at the facility.

### FIELD OF THE INVENTION

This invention relates to methods for providing memorials and more specifically to methods for providing memorials to loved ones while providing a unique means for generating charitable income.

### BACKGROUND OF THE INVENTION

With the ever-increasing cutbacks in federal and state support for nonprofit and charitable organizations, these organizations must work that much harder just to maintain their charitable services. Such organizations must look to alternative avenues for raising essential funds lost to government cutbacks and to declining private funding sources.

Many charitable organizations rely in part on gifts and donations given through estates or from surviving loved ones of deceased relatives as memorials. Gifts and donations are given for many reasons but primarily for altruistic purposes with the added incentives associated with tax deductions. Gifts and donations are given to any number of non-profit organizations including those with religious, charitable, educational, scientific or literary purposes, or those dedicated to preventing cruelty to children or animals and others unable to protect themselves.

Some people are proactive in planning for their death. Oftentimes they make arrangements either prior to their death as part of their estate planning or through instructions in their will as to their preferred funeral arrangements, dispersal of their financial estate, and the manner in which their bodily remains will be kept after they die.

Although there seemingly are a wide variety of ways in which a person might disperse their financial estate, there are quite limited ways in which a person's bodily remains are either maintained or disposed of after death. Not only are the limitations driven by physical limitations but also by financial limitations and the reasonableness of costs associated with either the maintenance or disposal of a person's remains. In general the two most common means are burial of the entire body in the ground or in a mausoleum, or by cremation and storage of the ashes in an urn or other such vessel for storage or subsequent scattering of the ashes. A very few individuals' bodily remains are kept in a cryogenic state for a variety of personal reasons at an extraordinarily high cost.

Deceased loved ones are typically memorialized either through charitable gifts to non-profit organizations and/or through the manner in which their bodily remains are kept. To date, there is a limited number of options in which these two types of memorials are combined, either through a trust or single gift to a church or cemetery at which the remains are buried or otherwise interred, or through a more recently offered means for providing a “living legacy” through Eternal Reefs, Inc. Eternal Reefs offers a memorial option in which the ashes of a loved one is mixed with cement and formed into a large hollow ball that is lowered into the ocean in the Gulf of Mexico and thereby permanently incorporated into an artificially created underwater habitat. A nameplate with the loved one's name is incorporated into the ball. The memorial option is offered as an ecologically friendly means of memorializing a loved one and helping to provide an underwater habitat. Although these underwater habitats offer a unique option, this option is permanent and makes it virtually impossible for loved ones visit the site. In fact, the company offers global positioning devices for surviving relatives who desire to subsequently find and visit the location. Obviously scuba equipment is necessary to actually view the habitat.

Although cemeteries currently offer indoor and outdoor mausoleum facilities in which individual crypts may be purchased for interring a body or an urn of ashes, these individual crypts are very expensive, immovable, and are part of the infrastructure of the mausoleum.

### SUMMARY OF THE INVENTION

It is therefore a primary object of this invention to provide a new method for memorializing a deceased loved one.

It is a further object of this invention to provide a method for memorializing a loved one while also financially supporting a charitable cause either close to the heart of the loved one or one of their surviving relatives or friends.

A preferred method of the invention for providing a memorial for a deceased person or animal whose bodily remains have been cremated into ashes, generally comprises the steps of: providing a pre-selected location at an indoor or outdoor facility; installing a self-contained crypt at said pre-selected location; providing at least a portion of said ashes; enclosing said ashes in a vessel; and enclosing said vessel in said crypt at said facility. The method may further comprise the steps of, identifying a non-profit organization; and providing a charitable donation to said non-profit organization in exchange for enclosing said ashes in said vessel in said crypt.

The crypt preferably comprises a plurality of inner compartments into one of which said vessel is placed, whereby a plurality of vessels may be enclosed within a single crypt. The crypt is preferably compact enough so as to be moveable.

The method may still further comprise the steps of, providing a website; and providing an obituary on said website of said deceased person.

The facility may be of any type but is preferably, although not limited to, facilities selected from a group consisting of a baseball stadium, a football stadium, a basketball arena, a hockey arena, racetrack, track and field stadium, soccer stadium, field hockey stadium, lacrosse stadium, jai alai stadium, and a hall of fame facility.

### DETAILED DESCRIPTION OF THE PREFERRED METHODS

The invention features a method for memorializing a deceased loved one while recognizing the interests of that person during their lifetime. Over the years of someone's lifetime they develop a variety of interests, some more so than others. Obviously these interests can take many forms from hobbies, to providing charitable services or helping with fundraising, to religious or entertainment-related interests, and to a host of sporting activities. With a doubt, one of the most popular forms of entertainment today is watching or actually participating in a sporting event. People follow teams and athletes with avid interest. Oftentimes people develop such a keen interest in a particular sport or a particular team that they spend a significant amount of their free time supporting and cheering on that team over their lifetime. Such connections are what brings people together as a family and a community and people consequently associate some of their fondest memories with these teams.

The methods of the invention, although applicable to a wide variety of interests, are particularly suited to memorializing an individual through his or her interest in a sport or specific team. The methods also enable players of the various sports to remain somehow physically connected to the sport or team to which they devoted their careers and lives. The methods are also suitable for memorializing a racing animal such as a racehorse, greyhound, sled dog, or even a polo pony.

Either the sporting arena or a particular non-profit organization could provide the initial impetus for the methods of the invention. A team, such as the Boston Red Sox, or the administrators of the stadium, such as Fenway Park in Boston, would designate or otherwise select an area within the park as the site for a memorial location. Although the sporting organization itself could feasibly provide the memorials for profit, it is preferred that the memorials be provided as an avenue through which a person could donate a gift or otherwise provide financial assistance to a non-profit or charitable organization. The methods of the invention are designed as an ideal way for charitable organizations to benefit from high profile sporting organizations at very little cost to the sporting organization. It is not only a way to memorialize the deceased loved one but also a way for a sporting organization to give back to the community and the devoted fans and athletes that support the various teams. Other sites, such as Arlington cemetery or churches that might otherwise be inaccessible or cost-prohibited to the general public could also offer such multi-compartment crypts to inter a small, but personally significant, amount of a deceased loved one's ashes.

A preferred method of the invention for providing the memorial for a deceased person or animal whose bodily remains have been cremated into ashes, generally comprises the steps of: providing a pre-selected location at a facility; installing a self-contained crypt at said pre-selected location; providing at least a portion of said ashes; enclosing said ashes in a vessel; and enclosing said vessel in said crypt at said sporting facility. The method may further comprise the steps of, identifying a non-profit organization; and providing a charitable donation to said non-profit organization in exchange for enclosing said ashes in said vessel in said crypt.

The vessel can be of any type suitable for containing ashes including, but not limited to, urns, metal and wooden boxes, cylinders, lockets, jewelry-sized urns, keepsake sized containers. However, the preferred vessel is square, rectangular or cubed-shaped to efficiently fit into a crypt made up of separate compartments. The crypt preferably comprises a plurality of inner compartments into one of which the vessel of ashes is placed, so that a plurality of vessels may be enclosed within a single crypt. The arrangement of compartments within the crypt is preferably such that each compartment is individually accessible and with partitions in between compartments.

A single crypt preferably comprises numerous small compartments. The compartments are preferably small and adapted to hold only a small fraction of an individual's ashes. The ashes of an individual to be interred within the crypt of the invention are preferably not co-mingled with the ashes of other individuals interred within the crypt. The number of compartments will be dependent on the size and type of facility, location, and the extent to which the crypt needs to be moveable. For example, it is envisioned that a single self-contained, moveable crypt, having an overall dimension of about 3 ft×3 ft×3 ft, could comprise more than a hundred compartments. This example is by no means intended to be a limitation only an illustration.

Depending on the facility and location, more than one crypt may be used. Depending on the size of the crypt or the size of the individual vessels, all or only a small portion of the deceased person's ashes may be sealed in a vessel. The preferred crypt is compact so as to be moveable or otherwise capable of being readily moved if needed.

If only a portion of an individual's ashes is sealed in a vessel in the memorial crypt, additional storage facilities for the remaining ashes may be provided in an area separate from the crypt but in or near the facility. It may be desired to have such separate storage facilities in the unfortunate event that the original memorial crypt is destroyed. Alternatively, the custodians of the memorial crypt or facility may also offer the deceased's loved ones the option of scattering the remaining ashes at a selected or designated location.

The compartments should be kept separate and individually secure and marked with the identifying information for the person whose ashes are contained with the compartment. The compartments and the vessels could be personalized or customized in any number of ways. The compartments or vessels could be made out of a variety of materials such as wood, metal, stone, or opaque glass. Photographs, paintings, etchings, carvings, drawings, or writings might also be applied to the outside or inside of the compartment or vessel.

Blocks of adjacent compartments may be purchased or leased, so that when the surviving loved ones, such as a spouse or child, later die, their ashes may interred next to their loved ones without disturbing or having to relocate other vessels to accommodate subsequent additions to the crypt.

The compartments could be either permanently sealed or locked, but accessible, if needed to remove a particular vessel. Likewise, the crypt could also be permanently sealed or merely locked, but accessible for adding or removing vessels as needed. If desired, to avoid having to repeatedly open the crypt, the custodian of the crypt might want to limit the addition of new vessels to a limited number of days in a year or only annually. In such cases, the custodian or facility might want to offer a group ceremony to mark the interment.

The crypt itself could be located inside a building or outside. Whether inside or outside, the crypt should be made of materials suitable for its location. The crypt could be located in a private setting for viewing only by loved ones or in a more public setting depending on the desires and intentions of the parties involved. Plaques, nameplates, pictures, or other means of memorializing the deceased could be placed on the outside of the crypt if desired and feasible for a particular location.

The method may still further comprise the steps of, providing a secure and preferably perpetual website; and providing an obituary or other additional information about the deceased person on website. It may be desired to offer surviving loved ones the option of personalizing the obituary or additional information. A person might also prefer to plan the arrangements, and write their own obituary, prior to or in preparation for their own death.

The facility need not be a sporting facility, however, it is envisioned that sporting facilities are the most likely facilities for such memorials. The sporting facility may be of any type but is preferably, although not limited to, facilities selected from a group consisting of a baseball stadium, a football stadium, a basketball arena, a hockey arena, racetrack, track and field stadium, soccer stadium, and a hall of fame facility. Non-sporting facilities may include, but are not limited to churches, cemeteries, schools, universities, colleges, parks, and fraternal organizations. A facility could be any building or location associated with an organization, activity or other such theme oriented group or site with which an individual would want recognized or associated after death.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A method for providing a memorial for a deceased person or animal whose bodily remains have been cremated into ashes, comprising the steps of,
providing a pre-selected location at an indoor or outdoor facility;
installing a self-contained crypt at said pre-selected location;
providing at least a portion of said ashes;
enclosing said ashes in a vessel; and
enclosing said vessel in said crypt at said facility.

2. The method of claim 1 further comprising the steps of,
identifying a non-profit organization; and
providing a charitable donation to said non-profit organization in exchange for enclosing said ashes in said vessel in said crypt.

3. The method of claim 1 wherein said crypt comprises a plurality of inner compartments into one of which said vessel is placed, whereby a plurality of vessels may be enclosed within a single crypt.

4. The method of claim 1, further comprising the steps of,
providing a website; and
providing an obituary on said website of said deceased person.

5. The method of claim 1, wherein said facility is selected from a group consisting of a baseball stadium, a football stadium, a basketball arena, a hockey arena, racetrack, track and field stadium, soccer stadium, and a hall of fame facility.

6. The method of claim 1, wherein said crypt is moveable.

7. The method of claim 1, wherein said crypt preferably comprises a plurality of inner compartments into one of which the vessel of ashes is placed.

8. The method of claim 7, wherein each of said compartments within the crypt are individually accessible.

9. The method of claim 1, wherein only a portion of said ashes is enclosed in said vessel.

10. A method for providing a memorial for a deceased person or animal whose bodily remains have been cremated into ashes, comprising the steps of,
providing a facility;
installing a crypt at said facility wherein said crypt comprises a plurality of individually accessible compartments;
providing only a portion of said ashes;
enclosing said ashes in a vessel; and
enclosing said vessel in one of said compartments.

11. The method of claim 10, wherein said crypt is self-contained and moveable.

12. The method of claim 11, wherein said crypt comprises at least 100 compartments.

13. A method for providing a memorial for a deceased person or animal whose bodily remains have been cremated into ashes, comprising the steps of,
providing a facility;
installing a self-contained crypt at said facility wherein said crypt comprises a plurality of compartments;
providing a small fraction of said ashes;
enclosing said ashes in a vessel; and
enclosing said vessel in one of said compartments.

14. The method of claim 13, wherein said crypt comprises at least 100 compartments.
